(19) United States
(12) Patent Application Publication
(10) Pub. No.: US 2025/0245742 A1
(43) Pub. Date: Jul. 31, 2025

(54) USER INTERFACE FOR AI-BASED TRADE INFORMATION AND RECOMMENDATIONS

(71) Applicant: MASTERCARD INTERNATIONAL INCORPORATED, PURCHASE, NY (US)

(72) Inventors: Amit Gupta, Dwark (IN); Bakul Kampani, Gurgaon (IN); Nitant Kaushal, New Delhi (IN); Vidisha Misra, Allahabad (IN)

(21) Appl. No.: 18/429,324

(22) Filed: Jan. 31, 2024

(51) Int. Cl. G06Q 40/04; G06F 3/0484; G06F 40/174; G06Q 10/0639

(52) U.S. Cl. CPC G06Q 40/04; G06F 3/0484; G06F 40/174; G06Q 10/06393

(57) ABSTRACT

The disclosure includes a user interface for displaying trade recommendations generated from different data sources. Transaction data records, trade data records, and regulatory data records are obtained and merged to create integrated records. Key performance index values are derived for each of the integrated data records. Inferences are generated from the key performance index values, and recommendations are made based thereon. The inferences and recommendations are represented and automatically arranged in the user interface.

### BACKGROUND

Trade is a fundamental aspect of global economics. Around the world, governments, private companies, and other various organizations constantly seek to optimize their trade policies. This involves understanding the current state of trade, including supply and demand for various products and services. However, obtaining accurate, up-to-date, and comprehensive data on trade and gaining actionable, real-time insights is challenging. This is further complicated by the need to navigate government regulations, customs, tariffs, and trade restrictions. Additionally, the data required for such technical analysis, including trade data among countries and trade corridors in the world, often comes from multiple sources, which may be generated and stored in various computerized formats. It is challenging to accurately and efficiently integrate this data, derive actionable recommendations and insights therefrom in real-time from this data, and present the information to a user for interaction and consumption.

### SUMMARY

The disclosed examples are described in detail below with reference to the accompanying drawing figures listed below. The following summary is provided to illustrate some examples disclosed herein. It is not meant, however, to limit all examples to any particular configuration or sequence of operations.

Some aspects disclosed herein are directed to an automated trade boosting tool. A computer system automatically generating trade solutions, the system comprising: a processor; a memory comprising computer program code, the memory and the computer program code configured to, with the processor, cause the processor to: obtain a plurality of transaction data records from a first data source, each transaction data record of the plurality of transaction data records comprising a plurality of first data fields; obtain a plurality of trade data records from a second data source, each trade data record of the plurality of transaction data records comprising a plurality of second data fields; map the plurality of first data fields to the plurality of second data fields; generate a plurality of integrated data records by collating the plurality of transaction data records and the plurality of trade data records based on the mapping; obtain a plurality of regulatory data records from a third data source; merge the plurality of regulatory data records into the plurality of integrated data records; derive a plurality of key performance index values for each merged integrated data record of the plurality of merged integrated data records; generate an inference associated with the plurality of key performance index values; generate a recommendation associated with the inference; and display the recommendation on a user interface by automatically arranging the recommendation based on the inference.

### BRIEF DESCRIPTION OF THE DRAWINGS

The present description will be better understood from the following detailed description read in light of the accompanying drawings, wherein:

FIG. 1 is a block diagram illustrating a trade boosting tool according to an example;

FIG. 2 is a block diagram illustrating a machine learning component according to an example;

FIG. 3 is an exemplary user interface illustrating an initial selection presentation;

FIG. 4 is an exemplary user interface illustrating a country profile;

FIG. 5 is an exemplary user interface illustrating a product profile;

FIG. 6 is an exemplary user interface illustrating an export revenue growth page;

FIG. 7 is an exemplary user interface illustrating a benchmark trade policies page;

FIG. 8 is an exemplary user interface illustrating a diversifying supply chain page;

FIG. 9 is a flow chart illustrating exemplary operations involving integrating data and generating recommendations.

FIG. 10 illustrates a block diagram of an example computing environment suitable for implementing some of the various examples disclosed herein.

Corresponding reference characters indicate corresponding parts throughout the drawings. In the figures, the systems are illustrated as schematic drawings. The drawings may not be to scale. Any of the drawings may be combined into a single example or embodiment.

### DETAILED DESCRIPTION

Aspects of the disclosure provide systems and methods for generating trade recommendations using data mining techniques and artificial intelligence (AI). In some examples, the disclosure includes a service platform that provides detailed, actionable, real-time recommendations and insights on trade data and policies with a single click in a user interface (UI). Aspects of the disclosure enable automatically generating trade solutions and up-to-date strategies pertaining to complex trade problems, including macroeconomic and policy issues, and analysis on demand and supply. Aspects of the disclosure analyze information at product and country level granularity for multiple use cases. Furthermore, aspects of the disclosure provide improvements in user accessibility and user interaction with a computer at least by making various functions and information accessible from one dashboard.

In particular, the disclosure enables integration of data from multiple data sources, such as transaction data, regulatory data, policy data, and macroeconomic indices, to form one integrated data set (e.g., a single database) from which insights and recommendations are inferred. Further, the disclosure updates the data in real-time such that changes in regulatory policies and tariffs are reflected instantaneously, using web scraping technology. Aspects of the disclosure integrate data from multiple sources at least by obtaining data records from the multiple sources, matching the data records in different formats, generating curated data records based on the matching, and filtering the curated data records, thereby providing more usable information. Aspects of the disclosure use less memory, have a reduced processing load, and use less bandwidth at least by filtering the curated data records, thereby improving the functioning of the underlying device. The disclosure performs data analysis at least by integrating data from various formats into a data structure with defined fields, and displaying data fields to a user in a user interface, thereby improving interaction between the user and the device. In addition, aspects of the disclosure improves interaction between the user and the device by automatically arranging recommendations based on predetermined criteria.

Recommendations are generated using a natural learning process and active learning. The disclosure generates trade solutions at a granular level in a very short span of time, leveraging commercial transaction data across the world and an unconventional algorithm that uses AI, machine learning (ML), and natural language processing (NLP).

The disclosure operates by analyzing transaction data (which includes spend values and transactions on cross-border trades) integrated with trade data (which includes trade value between different countries and regions by industry and product). The transaction data comprises product value and volume data, along with more detailed data about transactions including transaction location and time. In some examples, the transaction data comprises data fields such as industry, exact date and time of the transaction, and the exact location where the transaction is taking place. The transaction data includes precise geographic information of the transaction, which enables identifying product sources and trade hubs. In particular, the geographic information, in combination with other information included in the transaction data, may be advantageously utilized by multinational conglomerates to streamline sourcing for materials efficiently. Suppliers may use the information to pinpoint potential export destinations. Furthermore, the geographic information may provide understanding of logistical landscape.

The trade data, which is publicly available, is mapped to the transaction data, such that the data is integrated into a single integrated database of transactions. In some embodiments, the trade data is obtained in real-time from news feeds, websites, and/or published indices. In some examples, the trade data comprises macroeconomic data.

The disclosure operates in an unconventional way at least by combining the trade data and the transaction data per industry. Aspects of the disclosure provide unique insights based on the macroeconomic view from the trade data combined with the microeconomic view from the transaction data. The integrated data may be stored in a data structure with multiple fields inherited from the transaction data and the trade data, the data fields including country, region, personal identification number (PIN) code, merchant category code, industry, product spends, transactions, etc. The values stored in these data fields are used to capture insights. Insights are derived from various key performance index (KPI) characteristics such as spend growth, average transaction value, transaction growth, online/offline split of transactions, etc. Insights on some derived metrics, such as affinity to import for a particular product and/or industry are also available.

In some examples, the analysis may be carried out at various levels: industry, merchant categories, merchant, and product level. In some examples, the disclosure generates customized recommendations that focus on Small and Medium Enterprises (SME), or supply of a specific product from a specific country, a purchase pattern of a specific merchant category, and export and import from a particular location. In some examples, the recommendations are generated in real-time based on real-time data mining.

A user can start by clicking on a demand corridor (e.g., exporter and importer). Once the corridor is selected, the user is able to see the relevant KPIs for top three industries of that corridor. To get a detailed KPI view on any industry, the user can further select criteria, customize format and content. The user may select to customize KPIs. The user interface offers an end-to-end view. Aspects of the disclosure enable any user, including a company, a business owner, a government, or a multi-national organization, to devise a strategy on export-import, not only by industry, but by exact location and exact timing of the transaction. For example, governments may gain insights to bolster manufacturing in their countries.

In other examples, aspects of the disclosure provide transparent and up-to-date information on local regulations and various tariff restrictions.

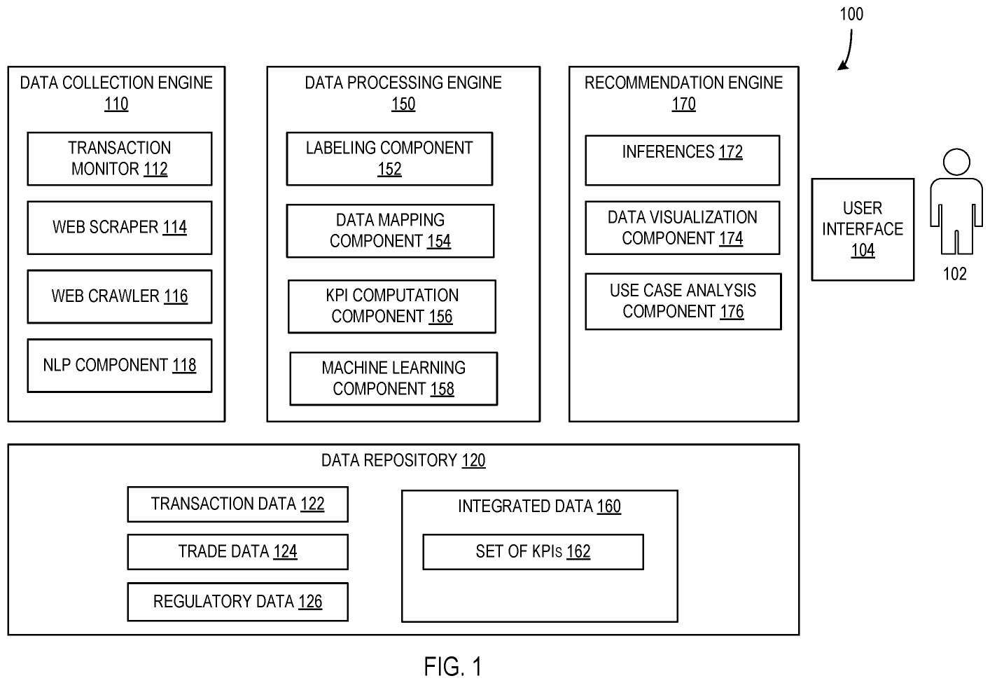

FIG. 1 is a block diagram illustrating a system 100 configured to process transaction data, trade data, and regulatory data and generate recommendations from the data. In some examples, the system 100 comprises a data collection engine 110, a data processing engine 150, and a recommendation engine 170.

The data collection engine 110 extracts and collects data from various sources. The data collection engine 110 comprises a transaction monitor 112, a web scraper 114, and a web crawler 116 to collect transaction data. trade data, and regulatory data respectively. In some embodiments, the transaction data, trade data, and regulatory data may be stored in a data repository 120. The web scraper 114 navigates the web by following links from one webpage to another systematically. The web crawler 116 navigates a network by following links from one webpage to another systematically.

In some embodiments, transaction data 122 is collected by the transaction monitor 112. In some examples, the transaction monitor 112 is implemented on a processor and configured to monitor and collect the transaction data 122. The transaction data 122 comprises information on various transactions, including overseas transaction data between exporters and importers, and each transaction in the transaction data 122 comprises multiple data fields, such as transaction value, volume, location of the transaction, date and time of the transaction, whether the transaction is online or offline, etc. In addition, in some embodiments, the transaction data 122 includes transaction spend growth rate, average transaction value, percentage of online and point of sale (POS) transaction between exporters and importers. In some embodiments, the transaction data 122 includes data at merchant level, including merchant category codes, geographic distribution of merchants, etc. Accordingly, the merchant category code may be a data field for the transaction data 122. In some embodiments, the transaction data 122 includes data associated with transactions across all trade corridors, which are designated routes or transportation networks that facilitate the movement of products, commodities, and services between regions, countries, or in some cases, continents.

The data collection engine 110 may use the web scraper 114 to collect the trade data from websites. The web scraper 114 automatically extracts data from websites on the Internet. In some embodiments, the web scraper 114 gathers information from web pages by sending HTTP requests to web servers, retrieving web content, and then parsing and extracting the trade data 124 from the parsed web content. In some embodiments, the trade data 124 is data collected from international trade organizations, such as World Integrated Trade Solution (WITS) by World Bank and World Trade Organization (WTO). However, WITS and WTO are examples of data sources for trade data 124, and trade data 124 may be collected from other sources that are associated with international trade.

In some embodiments, the web scraper 114 is configured to detect updates on a website by comparing the current state of a web page with a previously scraped version. After performing an initial scrape of the web pages, the web scraper stores the extracted data in a structured format, such as a database, comma-separated values (CSV) file, or JavaScript object notation (JSON) file. The web scraper 114 further extracts timestamps, version numbers, or other indicators of when the content was last updated and record this information with the extracted data. In order to detect updates, the web scraper 114 revisits the web page at regular intervals, such as hourly, daily, weekly, or monthly. In some embodiments, a user may decide the frequency of revisit that suits the user's need. In some embodiments, the web scraper 114 revisits to check for updates when a request for a recommendation is received. In some embodiments, a user may designate web pages to be revisited regularly, and web pages to be revisited only with requests. After each subsequent scrape, the web scraper 114 compares the current state of the web page with the previous version. If the web scraper 114 detects differences between the current state of the web page and the previous version, the web scraper 114 flags the page as updated, and proceed to extract and store the updated information. In some embodiments, the web scraper 114 is further configured to alert or notify the user when updates are detected.

The trade data 124 comprises information on international trades in products and services, and each transaction in the trade data 124 comprises multiple data fields, such as exporting country, importing country, trade volume, trade value, date of the transaction, etc. In some embodiments, the trade data 124 includes trade values between exporting and importing countries recorded according to the Harmonized Commodity Description and Coding System (HS). The HS comprises article and/or product descriptions using six digits, which may be broken down into three parts. The first two digits (HS-2) identify the chapter the products are classified, the next two digits (HS-4) identify grouping within the chapter, and the following two digits (HS-6) are even more specific. All countries classify products in the same way based on these six-digit classification. The trade data 124 may include trade value of exports and imports at HS-4 product level and HS-6 product level for the most recent five years. In some embodiments, the trade data 124 includes the HS as a data field.

In some embodiments, the web crawler 116 may be used to ensure that the trade data 124 is up to date. The web crawler 116 automatically and systematically browses and indexes the content of websites that are used to extract the trade data 124. The web crawler 116 may be set up to automatically revisit the websites or web pages periodically and collect new or updated data. Similar to the web scraper 114, the web crawler 116 may be configured to alert or notify the user when updates are detected (e.g., when some threshold level of updates have been received, when a particular type or category of updates have been received, etc.).

The data collection engine 110 collects regulatory data 126 using the web scraper 114 and the web crawler 116. In some examples, the regulatory data 126 comprises macroeconomic data, which represent governance and logistics of each country. In some examples, the regulatory data 126 comprise indices that indicate government effectiveness, regulatory quality, trade facilitation, globalization, and logistics performance. These indices gauge the effectiveness of government in strategizing and implementing trade policies as well as east of logistics for exporters and importers. In some examples, the regulatory data 126 comprises information on multinational treaties, Free Trade Agreements (FTAs), and tariff rates. In some examples, the regulatory data 126 is obtained from official government websites and publications. In some examples, a web crawler 116 is used to extract the regulatory data 126. In some examples, a web crawler 116 and a web scraper 114 are used in combination to obtain the regulatory data 126.

In some embodiments, a natural language processing (NLP) component 118 is employed to capture syntactic and semantic relations between words and phrases in an unsupervised way. In some embodiments, the NLP component 118 can be applied to text in any language. The NLP component 118 identifies the language of the document first, tokenizes text into smaller units, such as words or phrases, and tags words in the language with their part of speech. From there, the NLP component 118 identifies named entities, such as names of people, organizations, locations, countries, industries, products, and more. In some embodiments, machine translation models may be used to convert foreign language text into a language the user understands. The translation may be performed before or after data extraction. After the text is processed, NLP techniques are used to extract data such as dates, numbers, locations, countries, industries, keywords, or any other information. In some embodiments, the NLP component 118 is trained on a wide range of languages and configured to work across multiple languages.

The transaction data 122, the trade data 124, and the regulatory data 126 may be stored in a data repository 120. The data repository 120 is a single database that stores the transaction data 122, the trade data 124, and the regulatory data 126.

The data processing engine 150 processes the data collected by the data collection engine 110 and integrates the transaction data 122, the trade data 124, and the regulatory data 126 into the integrated data 160 in the data repository 120. The data processing engine 150 further processes the integrated data 160 to derive a set of Key Performance Indices (KPIs).

In some examples, the data in the data repository 120 are labeled by a labeling component 152. In some examples, the HS-6 level product data field of the trade data 124 is labeled and categorized into standardized industries. A mapping component 154 maps merchant category code data field of the transaction data 122 to the labeled HS-6 data field of the trade data 124. In some embodiments, the merchant category code may be customized. After mapping, data fields of the transaction data 122 and the data fields of trade data 124 are compared. Based on the mapping, the transaction data 122 and the trade data 124 are collated and integrated into the integrated data 160. The data values of regulatory data 126 are matched and merged into the integrated data 160 to add more values and details to the integrated data 160. The regulatory data 126 adds recent trade policy-related data to the integrated data 160, such that the recommendations are more current and relevant. A KPI computation component 156 computes KPIs from the integrated data 160. The regulatory data 126 is matched to corresponding products, industries, and countries, and merged into the corresponding integrated data 160 by adding values to the data fields.

In some embodiments, after data from multiple sources are integrated, the integrated data 160 is searched to identify redundant data records. In addition, the integrated data 160 is filtered periodically to remove redundant data, irrelevant data, and old data. Integrating data from multiple sources in a single database and filtering the integrated data can save computer storage resources by enabling the database and the processing engine to process the data more efficiently and faster.

In some embodiments, each integrated data record of the integrated data 160 has a country, an industry, and a product as data fields, along with other data fields inherited from the transaction data and the trade data, such as trade volume, merchant code, transaction location, trade timeframe, etc. In some examples, each integrated data record of the integrated data 160 comprises a plurality of data fields, including a country, an industry, a product, a set of trade metrics (trade volume and trade value), and a set of KPIs 162. In some embodiments, once the trade data 124 is integrated with the transaction data 122, the set of KPIs 162 is calculated according to predefined formulae embedded within the system. In some embodiments, the system 100 comprises a KPI library, which comprises formulae for calculating the set of KPIs 162. The user may add new KPIs by adding a new formula for the new KPI to the KPI library. In some embodiments, the new formula is defined at the time of inclusion and built into the KPI library. In some embodiments, the KPI library includes the formulae such as:

$$Average Spend per Card = \frac{Total Spend Amount}{Number of Credit Cards}$$

$$Average Ticket Size = \frac{Total Spend Amount}{Number of Transactions}$$

However, the formulae in KPI library are not limited to these examples and the KPI library may include any formula deem useful by the user.

In some examples, additional KPIs are derived from the integrated data 160 by the KPI computation component 156 and stored in the integrated data 160. The additional KPIs may include a spend growth in corridor in Compound Annual Growth Rate (CAGR), a transaction growth in corridor in CAGR, an average transaction value in corridor, total import/export growth rate, spend growth in corridor, contribution of exporter to importer, affinity to import for super industry, contribution of super industry to overall SME imports, etc. The set of KPIs 162 also includes trade policy related indices and indicators, such as tariffs, regulatory quality index, trade facilitation index, globalization index, logistics performance, ease of logistics, ease of trade, etc. The KPIs are not limited to these examples and the user may add or modify the KPIs to obtain useful indicators.

The integrated data 160 and the set of KPIs 162 is further analyzed to assign a set of scores or a set of weights to each KPI of the set of KPIs 162. Each score of the set of scores is applied to each KPI of the set of KPIs 162 to generate a set of weighted KPIs. In some embodiments, the weighted KPIs are combined to compute a total KPI. In some embodiments, countries can be ranked based on any KPI of the set of KPIs 162, such as ease of trade, spend growth rate, or transaction growth rate. In some embodiments, the integrated data 160 may be arranged into multiple views of countries, industries, and products based on the set of KPIs 162 or the total KPIs.

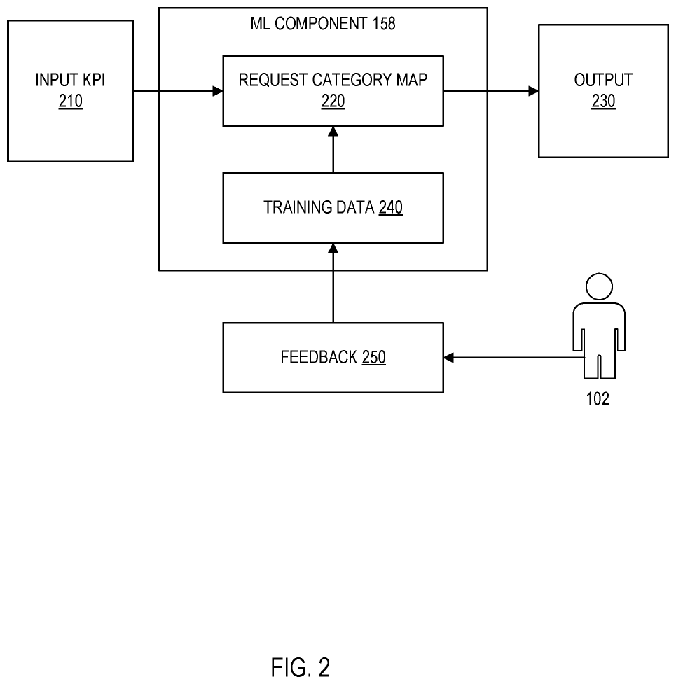

In some examples, machine learning (ML) techniques are used to categorize and assign scores. In some embodiments, an ML component 158 assigns the set of weights to the set of KPIs 162 based on historic data. The ML component 158 may be trained with training data generated from historic data. The categorization and score assignment by the ML component 158 is described in more detail in relation to FIG. 2.

In some embodiments, a recommendation engine 170 generates inferences 172 associated with the set of KPIs 162, the set of weighted KPIs, and the total KPIs. From KPIs related to ease of entry, such as status of multinational trade agreements and tariff rates, affinity to trade may be inferred. In some embodiments, the recommendation engine 170 generates a prioritization matrix, which countries, products, and industries are prioritized based on supply-demand analysis. Inferences 172 include benchmarking data that identifies successful country, product, trade policies etc. Inferences 172 may further represent a competitive advantage analysis, for example which focuses on a particular country and analyzes the country's strength in terms of products, industries, and logistics. In some embodiments, generating inferences further comprises generating a plurality of trade scenarios. Each trade scenario is associated with at least one country in the integrated data 160. For each trade scenario, integrated data 160 and the set of KPIs 162 is analyzed with regard to an industry or a product of a particular country to find trade triggers. For example, results of trade scenario analysis may include “Italy's toy industry is growing at 6% CAGR,” “India's global exports in telecom industry is 5%, as opposed to export to the USA is 1%,” “Netherland's tariff rates are highest among G20 nations,” or “UK's demand in machinery industry is $256 billion with 6% CAGR.”

The recommendation engine 170 uses ML techniques to generate the inferences 172. The ML component used by the recommendation engine 170 may be the same ML component 158 used by the data processing engine 160 to score and categorize the set of KPIs 162. In some embodiments, a different ML component may be employed to generate inferences. The ML component is initially trained based on historic data, and fine-tuned with additional data as the data processing engine 150 streams more data into the recommendation engine 170.

The recommendation engine 170 uses NLP to generate natural language output from the inferences 172. For example, from “the trade scenarios associated with China include China having 6% CAGR in auto components industry over 6 years”, the recommendation output is presented as “Auto components industry in China has seen a consistent growth of 6% CAGR over 6 years.”

In some embodiments, the recommendation engine 170 uses a data visualization component 174 to present information on the user interface 104. The data visualization component 174 is configured to obtain inferences and KPIs associated with user's selections (country, industry, timeframe, KPI, etc.) and present them to the user. The data visualization component 174 selects appropriate data visualization tools and techniques depending on the nature of data and the user's preferences. These tools and techniques include charts, graphs, tables, diagrams, text, etc. These are examples and the presentation is not limited to these formats. The information (KPIs and inferences) to be presented can be customized based on the user's preferences. For example, a profile for a country includes an overview of the selected country, most relevant KPIs, and top exporting products and top importing products.

In some embodiments, the data visualization component 174 allows the user to customize the presentation format, layout, and content. For example, the user may select how many KPIs are presented, what KPIs are included, and how to display them (top to bottom, left to right, etc.). In some embodiments, the layout, format, and content are automatically selected and arranged based on historic user preferences. After initial use and customization, a use case analysis component 176 analyzes the user's interactions and identifies use patterns. Based on the identified use patterns, the layout, format, and content of the presentation are determined. In some embodiments, the user interface 104 displays KPIs based on the frequency of appearance on the user's search. For example, based on the frequency of search, the most frequently searched KPIs are displayed. The KPIs can be displayed from left to right, or top to bottom, based on the frequency of search. In some other embodiments, the use case analysis component 176 determines the user's pattern of interacting with KPIs or inferences, and the data visualization component 174 displays the data items based on the frequency of the user's interaction with the item. In some embodiments, the use case analysis component 176 analyzes a pattern of user's behavior and reflect it to the display. For example, if the user frequently searches for trade volume of the selected country for a particular industry, then the trade volume for the industry is displayed in the user interface 104 in a prominent place, such as the top of the user interface 104, above the trade volume for other industries. In some embodiments, the user frequently selects to view the country's profile after viewing benchmark data, the user interface 104 may prompt the user to view the selected country's profile while the user is on the benchmark display.

In some embodiments, the data visualization component 174 generates interactive features. The interactive features allow the user to explore the data further by hovering over data points, zooming in, or filtering the data. For example, each data point, such as KPI, rank, or top products, is accompanied by “click here to see more details” button. In some embodiments, instead of clicking the button, simply hovering over the data item produces a box with more details overlapping on the display.

FIG. 2 is a block diagram illustrating the ML component 158 configured to categorize and score the set of KPIs 162. The ML component 158 is initially trained with historic transaction data, historic trade data, and historic regulatory data, and fine-tuned as it processes more data.

During and after the training process, the ML component 158 is configured to receive a set of input KPIs 210, apply a category map 220 to the input KPIs 210, where the category map includes categorization or classification logic that maps the input KPIs 210 to output 230. The set of input KPIs 210 may be selected from the set of KPIs 162 to be analyzed by the ML component 158. The ML component 158 may analyze all or part of the set of KPIs 162. The output 230 includes output category for each input KPI 210, or a score or a weight for each input KPI 210. During the training process, the category map 220 is altered, adjusted, or otherwise changed based on the training data 240, such that, after training is complete, application of the category map 220 to input KPI 210 yields output 230 that are the same as or at least substantially similar to the responses associated with the same input KPI in the training data 240. The training of the ML component 158 and associated adjustments made to the category map 220 may be based on analysis of the training data 240, identification of patterns of KPIs that are associated with particular score or category, etc. Further, in some examples, the training of the ML component 158 and adjustment of the category map 220 is performed using deep learning classification algorithms and/or other machine learning techniques.

In some embodiments, the ML component 158 may be fine-tuned with feedback 250 from the user 102. The output 230 is presented to the user 102, and the user 102 may provide feedback 250 by adjusting the output 230. For example, the user 102 may assign a different score to the input KPI 210, assign the input KPI 210 to a different category, or create a new category. The adjustment made in the feedback 250 is added to the training data 240 to create a second training data for fine tuning. The ML component 158 is fine-tuned with the second training data.

In some embodiments, the ML component 158 includes a machine learning module that comprises a trained regressor such as a random decision forest, a directed acyclic graph, a support vector machine, a convolutional neural network or other neural network, or another trained regressor. Such a trained regressor may be trained using the training data 240 and the feedback data 250.

In an example, the ML component 158 makes use of training data pairs when applying machine learning techniques and/or algorithms. Millions of training data pairs (or more) may be stored in a machine learning data structure. In some examples, a training data pair includes historic KPI value and the associated category or score. The pairing of the two values demonstrates a relationship between the feedback data value and the adjustment values that may be used by the machine learning module to determine future interval adjustments according to machine learning techniques and/or algorithms.

In some embodiments, the ML component 158 is trained in unsupervised manner. The category map 220 learns to find pattern from unlabeled input KPIs 210 without reference to labeled outcome. In some embodiments, the ML component 158 uses unsupervised machine learning techniques to create clusters with unlabeled input and output data. In some embodiments, clustering techniques such as k-means clustering, hierarchical clustering, mean shift clustering, and density-based clustering are used.

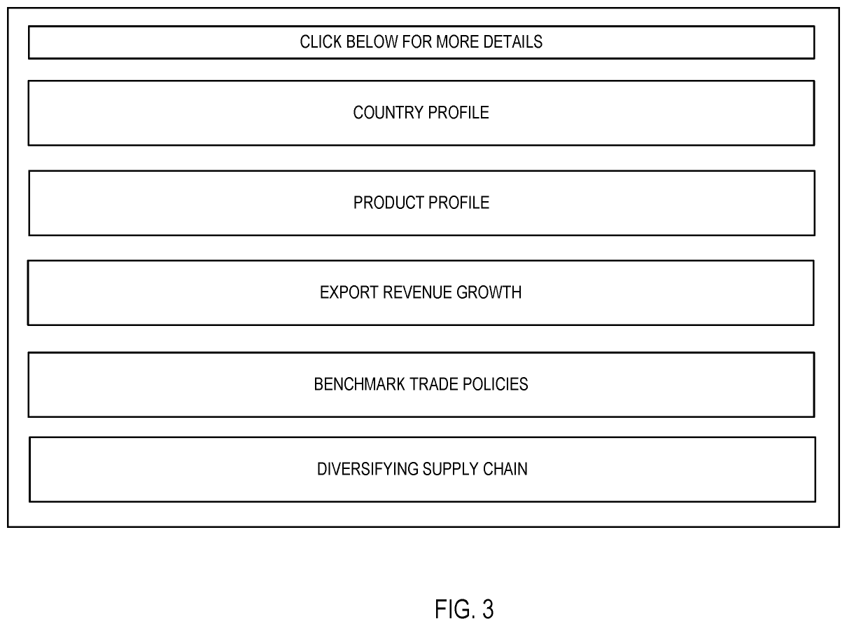

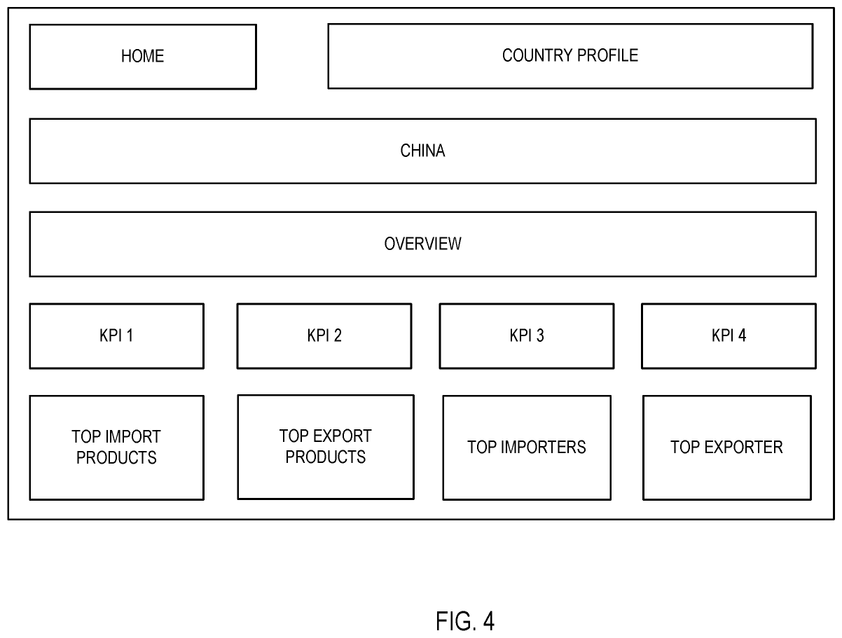

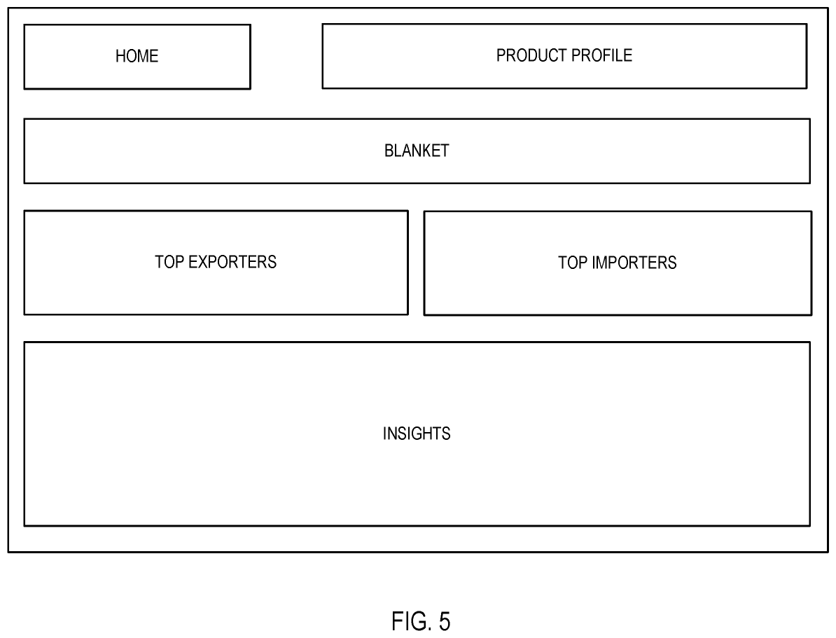

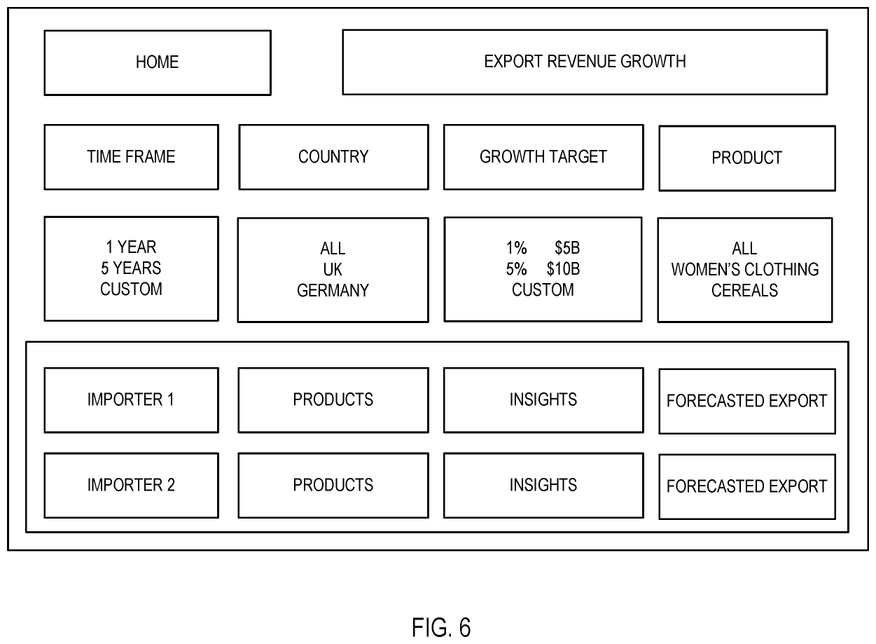

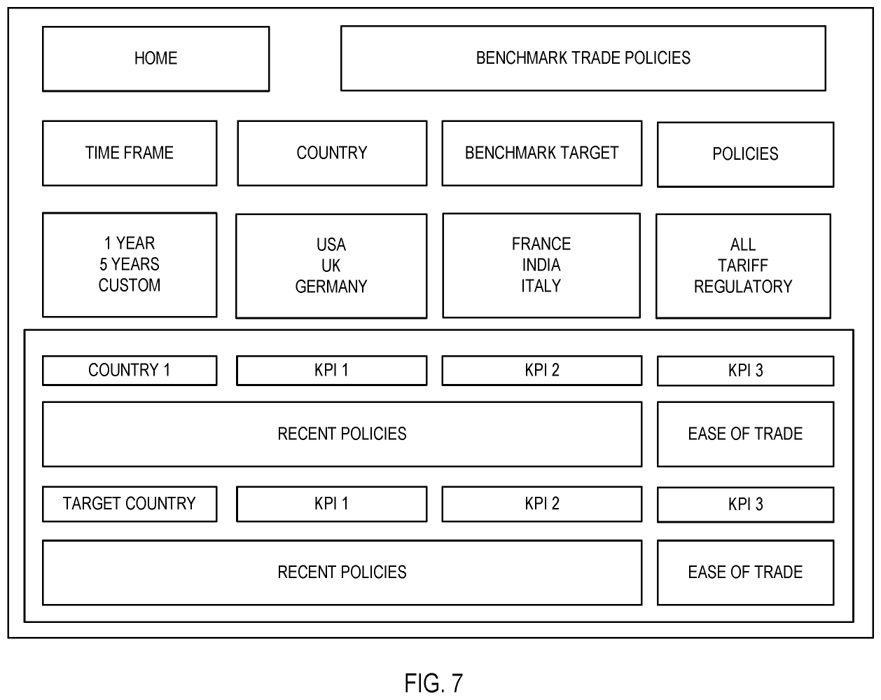

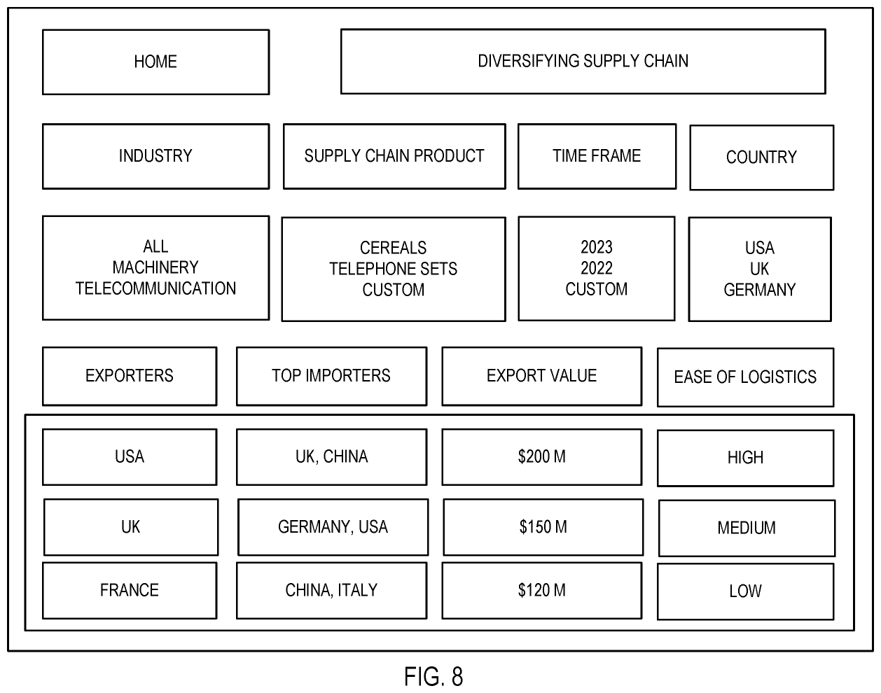

FIG. 3 illustrates an exemplary user interface for an initial selection page. A user (e.g., the user 102) may select to view one of the presented menu. However, these selections are provided as examples. The user may customize the initial menu by adding new menus, deleting any of these selections, or modifying content or functions. For example, the initial selection may include “country profile,” “product profile,” “export revenue growth,” “benchmark trade policies,” and “diversifying supply chain.” The selection page may provide the interactive features such that more detailed explanation appears when the user hovers over data points or clicks the data item. The user can view curated inferences and KPIs associated with a particular country when the user selects the “country profile.” The country profile page is described in more detail in relation to FIG. 4. Clicking “product profile” enables the user to view curated inferences and KPIs associated with a particular product. The product profile page is described in more detail in relation to FIG. 5. “Export revenue growth” page enables the user to select a time frame, a country, target growth rate, and a product, and based on the user's selections, provides a list of importers and products that satisfy the target growth rate. The “export revenue growth” page is described in more detail in relation to FIG. 6. “Benchmark trade policies” page enables the user to select a county and a benchmarking target country, and provides a comparison between the country and target country on selected KPIs. The benchmark trade policies page is described in more detail in relation to FIG. 7. Lastly, “diversifying supply chain” page prompts the user to select an industry, supply chain products, a time frame, and a country, and based on the user's selections, display KPIs associated with exporter of the products, top importers of the products, the export volume, and ease of logistics. The diversifying supply chain page is described in more detail in relation to FIG. 8.

FIG. 4 illustrates an exemplary user interface for a country profile presentation. When a user (e.g., the user 102) selects to view a country profile, a user interface (e.g., the user interface 104) presents curated inferences and recommendation associated with a selected product. For example, an overview of the selected country is provided in a text form. For China, after obtaining information associated with GDP, total export, and total import, the overview may be presented as text “In 2020, China was the number 2 economy in the world in terms of GDP, the number 1 in total exports, the number 2 in total imports, the number 77 economy in terms of GDP per capita.” However, presentation of the overview is not limited to text form, but can be any other format the user prefers, such as a table, chart, or graph. In addition, the information (KPIs and inferences) included in the overview can be customized based on the user's preference. For example, the overview may describe ease of entry, trade volume in a specific industry or product, trade trend over the last five years, or current value of a particular KPI of interest.

In some embodiments, below the overview, some KPIs of interest may be presented. The KPIs may include regulatory quality index, trade facilitation index, globalization index, logistics performance index. These KPIs may be presented as rankings, such as 109th out of 192 countries, or presented as a percentage or a number. In some embodiments, the user may select how many KPIs are presented and what KPIs are included. Below the KPIs, the selected country's top import products, top export products, and top importers are presented. Similar to the KPIs, the user is able to customize what information is to be displayed here.

FIG. 5 illustrates an exemplary user interface for a product profile presentation. When a user (e.g., the user 102) selects to view a product profile, a user interface (e.g., the user interface 104) presents curated inferences and recommendation associated with the selected product. For example, top exporter and its exporting volume and top importer and its exporting volume may be provided on the top of the page. Additionally, or alternatively, other relevant KPIs may be provided. For example, total trade volumes for top sub-category products may be provided. In some embodiments, insights, or recommendations, generated from the inferences, may be provided. The insights may describe trending products within the product category, which have increased in trade volume in recent years. For example, for “blanket,” one of the insights provided is “increasing trade volume in blankets made with eco-friendly material,” where it is further explained that “with an increasing awareness of environmental issues, eco-friendly materials like organic cotton, bamboo fiber, and recycled polyester are becoming more popular.” In addition, the insights may introduce a sub-category product, “electric blankets” is gaining popularity, because “there has been a trend toward more high-tech electric blankets with features like smart controls and automatic shut-off.”

FIG. 6 illustrates an exemplary user interface for an export revenue growth presentation. In some embodiments, the export revenue growth page presents drop-down menu for the user to select a time frame, a country, target growth rate, and a product. The user may select 1 year or 5 year, or customize the search by specifying a time period of interest. In some embodiments, as described above, a use case analysis component (e.g., the use case analysis component 176) analyzes user's selections and present the most selected time frame on top. This may apply to other selections, including country, growth target, and product. The user is enabled to select “all” for country and product, such that every available country and product that has been analyzed by the data processing engine are searched to find importers and products that match the selected target growth rate during the selected time frame. The export revenue growth page provides a list of importers and products along with insights and forecasted export. The insights and forecasted export values are generated using the machine learning techniques similar to the techniques described above. The insights include details about recent trade trend to provide explanation as to why the importers and products are recommended. For example, “France” is presented as the importer for leather footwear, and the accompanying insight may explain that “USA exports 5% of leather footwear to France, whereas France suffices 15% of global demand.”

FIG. 7 illustrates an exemplary user interface for a benchmark trade policies presentation. The benchmark trade policies page enables the user to select a time frame, a county, a benchmark target country, and types of policies. The user may select a time frame, a country, a benchmark target country, and types of policies from respective drop-down menus. After selecting these criteria, relevant KPIs associated with the selected types of policies are provided. In some embodiments, these KPIs are selected based on the user's historic preferences. Further details on recent policies may be provided under the KPIs such that the user is enabled to learn more details about the recent policies involving the selected countries. In some embodiments, ease of trade, generated from the machine learning component, is provided. The ease of trade is indicated as levels, such as low, medium, and high.

FIG. 8 illustrates an exemplary user interface for a diversifying supply chain. The user may advantageously use the benchmark trade policies page to gain insights on supply chain of a selected product. The user is prompt to select an industry, supply chain product within the industry, a time frame, and a county from respective drop-down menus. In some embodiments, based on the selection history of the user, the most selected items are presented on top. After selecting the criteria, top exporters of the selected product, and countries that are importing the selected product from the respective exporter, total export values for the exporting countries, and ease of logistics are presented as a table. Additionally, or alternatively, this information is presented in a different format, such as a bar graph, pie chart, or diagram. In some embodiments, ease of logistics is generated from the machine learning component, and indicated as levels, such as low, medium, and high. Additionally, or alternatively, other KPIs than the ease of logistics may be presented.

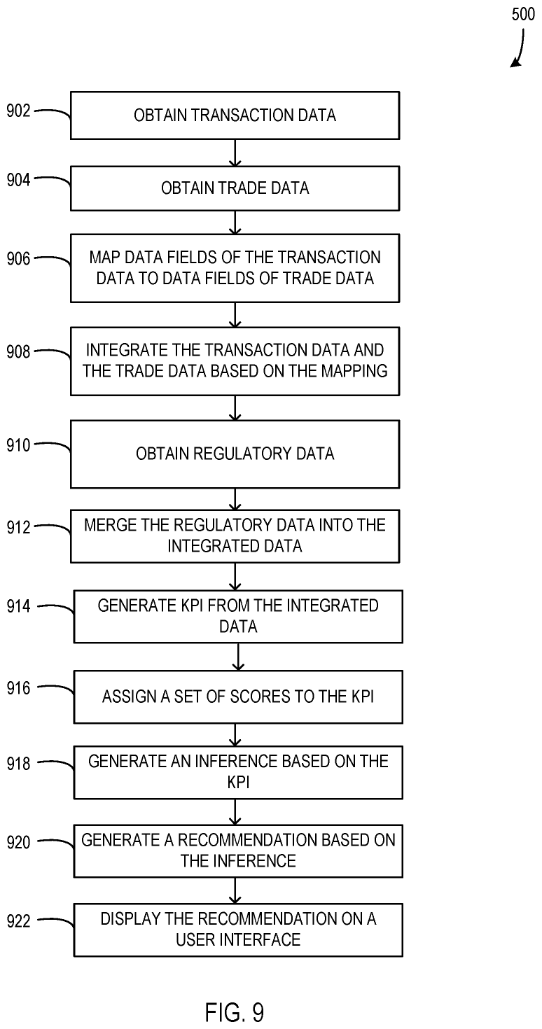

FIG. 9 is a flow chart illustrating exemplary operations involving in generating trade boosting recommendations. The data collection engine 110 obtains the transaction data in operation 902. The data collection engine 110 obtains the trade data in operation 904. Operation 904 includes using a web scraper and/or a web crawler to gather data from relevant websites. Operation 904 also includes using an NLP component to process the gathered data and extract the trade data. Because the transaction data and the trade data are in different data format and have different data fields, operation 906 includes mapping the data fields of the transaction data to the data fields of the trade data. Operation 906 also includes labeling the trade data and transaction data, such that both data are labeled and categorized into standardized industries. In some embodiments, operation 906 involves mapping the merchant category code data field of the transaction data to the HS-6 data field of the trade data 124. After mapping, the transaction data and the trade data are integrated in operation 908, by comparing data fields of the transaction data 122 and the data fields of trade data 124, and removing any redundant data. Based on the mapping, the transaction data and the trade data are collated and integrated into the integrated data.

The data collection engine 110 obtains regulatory data in operation 910. The regulatory data is obtained using the web scraper and/or web crawler, and processed by the NLP component. The processed regulatory data is added to the integrated data in operation 912. Operation 912 includes searching the integrated data to find matching data record for the regulatory data, and adding the matched regulatory data to the appropriate data field of integrated data. The regulatory data is merged into the integrated data in operation 912.

The data processing engine computes a set of KPIs from the integrated data in operation 914. Operation 914 includes analyzing the integrated data to compute the set of KPIs. In some embodiments, computing the set of KPIs includes using machine learning techniques to predict a value or identify a pattern. The set of KPIs includes various trade related indices and metrics, such as total import/export growth rate, spend growth in corridor, transaction growth in corridor, as well as trade policy related indices and indicators, such as tariffs, regulatory quality index, trade facilitation index, globalization index, logistics performance, ease of logistics, ease of trade, etc. Operation 916 assigns scores or weights to each KPI of the set of KPIs. Machine learning techniques, similar to techniques described in relation to FIG. 2, are used to assign the scores to the KPIs. After applying the scores or weights to the KPIs, the weighted KPIs is accumulated to generate total KPIs. The total KPIs and the set of weighted KPIs are used to rank the countries, industries, or products. The ranks and the KPIs, including the weighted KPIs and total KPIs, are used to generate inferences in operation 918. The inferences are generated for a plurality of trade scenarios, where each trade scenario involves a country and a particular trade situation. From the inferences, the recommendation engine generated recommendations in preferred formats, including tables, graphs, and/or text in operation 920. The generated recommendations are displayed via the user interface, where the layout, format, and content of the display are automatically arranged as described herein.

### Additional Examples

Some aspects and examples disclosed herein are directed to a system for trade automatically generating trade solutions, the system comprising: a processor; a memory comprising computer program code, the memory and the computer program code configured to, with the processor, cause the processor to: obtain a plurality of transaction data records from a first data source, each transaction data record of the plurality of transaction data records comprising a plurality of first data fields; obtain a plurality of trade data records from a second data source, each trade data record of the plurality of transaction data records comprising a plurality of second data fields; map the plurality of first data fields to the plurality of second data fields; generate a plurality of integrated data records by collating the plurality of transaction data records and the plurality of trade data records based on the mapping; obtain a plurality of regulatory data records from a third data source; merge the plurality of regulatory data records into the plurality of integrated data records; derive a plurality of key performance index values for each merged integrated data record of the plurality of merged integrated data records; generate an inference associated with the plurality of key performance index values; generate a recommendation associated with the inference; and display the recommendation on a user interface by automatically arranging the recommendation based on the inference.

Some aspects and examples disclosed herein are directed to a method for generating trade solutions, comprising: obtaining a plurality of transaction data records from a first data source, each transaction data record of the plurality of transaction data records comprising a plurality of first data fields; obtaining a plurality of trade data records from a second data source, each trade data record of the plurality of transaction data records comprising a plurality of second data fields; mapping the plurality of first data fields to the plurality of second data fields; generating a plurality of integrated data records by collating the plurality of transaction data records and the plurality of trade data records based on the mapping; obtaining a plurality of regulatory data records from a third data source; merging the plurality of regulatory data records into the plurality of integrated data records; deriving a plurality of key performance index values for each merged integrated data record of the plurality of merged integrated data records; generating an inference associated with the plurality of key performance index values; generating a recommendation associated with the inference; and displaying the recommendation on a user interface by automatically arranging the recommendation based on the inference.

Some aspects and examples disclosed herein are directed to one or more computer storage devices having computer-executable instructions that, upon execution by a processor, cause the processor to: obtain a plurality of transaction data records from a first data source, each transaction data record of the plurality of transaction data records comprising a plurality of first data fields; obtain a plurality of trade data records from a second data source, each trade data record of the plurality of transaction data records comprising a plurality of second data fields; obtain a plurality of regulatory data records from a third data source; map the plurality of first data fields to the plurality of second data fields; generate a plurality of integrated data records by collating the plurality of transaction data records and the plurality of trade data records based on the mapping; merge the plurality of regulatory data records into the plurality of integrated data records; derive a plurality of key performance index values for each merged integrated data record of the plurality of merged integrated data records; generate an inference associated with the plurality of key performance index values; generate a recommendation associated with the inference; and display the recommendation on a user interface by automatically arranging the recommendation based on the inference.

Alternatively, or in addition to the other examples described herein, examples include any combination of the following:
wherein each integrated data record of the plurality of integrated data record has a plurality of integrated data fields.
wherein the plurality of integrated data fields comprises a country, an industry, and a product.
assigning a set of weights to the plurality of key performance index; deriving a plurality of weighted key performance index values by applying the set of weight to the plurality of key performance index values; and combining the plurality of weighted key performance index values to generate a total key performance index value for each merged integrated data record of the plurality of merged integrated data records.
wherein the set of weights to the plurality of key performance index is assigned by a machine learning component.
wherein the machine learning component is trained using training data, and fine-tuned using user feedback.
wherein the retrained machine learning component is used to assign the set of weights to the plurality of merged integrated data records.
wherein merging the plurality of regulatory data records into the plurality of integrated data records comprises analyzing the plurality of regulatory data records and matching the plurality of regulatory data records to the plurality of integrated data records.
wherein generating the inference associated with the plurality of key performance index values comprises: generating a plurality of trade scenarios, wherein each trade scenario of the plurality of trade scenarios is associated with a country and an industry; recognizing a pattern in the plurality of key performance index values associated with each trade scenario of the plurality of trade scenarios; and generating the inference for each trade scenario of the plurality of trade scenarios based on the recognized pattern.
wherein the pattern in the plurality of key performance index values is recognized by a machine learning component.
receiving a user input through the user interface; checking the first data source, the second data source, and the third data source for updates associated with the user input; updating the plurality of key performance index values based on the updates; updating the inference based on the updated plurality of key performance index values; and generating an updated recommendation based on the updated inference.

### Exemplary Operating Environment

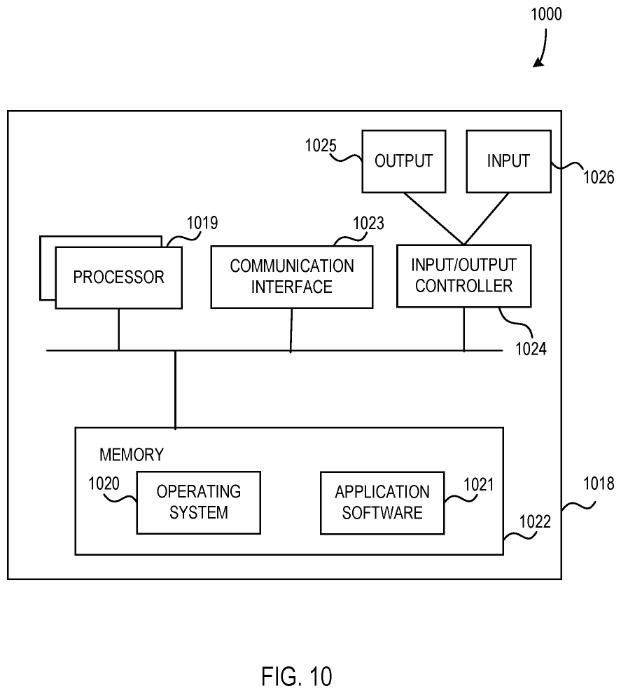

The present disclosure is operable with a computing apparatus according to an embodiment as a functional block diagram 1000 in FIG. 10. In an example, components of a computing apparatus 1018 are implemented as a part of an electronic device according to one or more embodiments described in this specification. The computing apparatus 1018 comprises one or more processors 1019 which may be microprocessors, controllers, or any other suitable type of processors for processing computer executable instructions to control the operation of the electronic device. Alternatively, or in addition, the processor 1019 is any technology capable of executing logic or instructions, such as a hard-coded machine. In some examples, platform software comprising an operating system 1020 or any other suitable platform software is provided on the apparatus 1018 to enable application software 1021 to be executed on the device. In some examples, validating trained models in stage environments prior to deploying them in production environments as described herein is accomplished by software, hardware, and/or firmware.

In some examples, computer executable instructions are provided using any computer-readable media that is accessible by the computing apparatus 1018. Computer-readable media include, for example, computer storage media such as a memory 1022 and communications media. Computer storage media, such as a memory 1022, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium does not include a propagating signal. Propagated signals are not examples of computer storage media. Although the computer storage medium (the memory 1022) is shown within the computing apparatus 1018, it will be appreciated by a person skilled in the art, that, in some examples, the storage is distributed or located remotely and accessed via a network or other communication link (e.g., using a communication interface 1023).

Further, in some examples, the computing apparatus 1018 comprises an input/output controller 1024 configured to output information to one or more output devices 1025, for example a display or a speaker, which are separate from or integral to the electronic device. Additionally, or alternatively, the input/output controller 1024 is configured to receive and process an input from one or more input devices 1026, for example, a keyboard, a microphone, or a touchpad. In one example, the output device 1025 also acts as the input device. An example of such a device is a touch sensitive display. The input/output controller 1024 may also output data to devices other than the output device, e.g., a locally connected printing device. In some examples, a user provides input to the input device(s) 1026 and/or receives output from the output device(s) 1025.

The functionality described herein can be performed, at least in part, by one or more hardware logic components. According to an embodiment, the computing apparatus 1018 is configured by the program code when executed by the processor 1019 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for [independent claim steps with “exemplary means for” before each verb].

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed:

1. A computer-implemented method comprising:
obtaining a plurality of transaction data records from a first data source, each transaction data record of the plurality of transaction data records comprising a plurality of first data fields;
obtaining a plurality of trade data records from a second data source, each trade data record of the plurality of transaction data records comprising a plurality of second data fields;
mapping the plurality of first data fields to the plurality of second data fields;
generating a plurality of integrated data records by collating the plurality of transaction data records and the plurality of trade data records based on the mapping;
obtaining a plurality of regulatory data records from a third data source;
merging the plurality of regulatory data records into the plurality of integrated data records;
deriving a plurality of key performance index values for each merged integrated data record of the plurality of merged integrated data records;
generating an inference associated with the plurality of key performance index values;
generating a recommendation associated with the inference; and
displaying the recommendation on a user interface including automatically arranging the recommendation on the user interface based on the inference.

2. The method of claim 1, wherein each integrated data record of the plurality of integrated data records has a plurality of integrated data fields.

3. The method of claim 2, wherein the plurality of integrated data fields comprises a country, an industry, and a product.

4. The method of claim 1, further comprising:
assigning a set of weights to the plurality of key performance index values;
deriving a plurality of weighted key performance index values by applying the set of weight to the plurality of key performance index values; and
combining the plurality of weighted key performance index values to generate a total key performance index value for each merged integrated data record of the plurality of merged integrated data records.

5. The method of claim 1, wherein merging the plurality of regulatory data records into the plurality of integrated data records comprises analyzing the plurality of regulatory data records and matching the plurality of regulatory data records to the plurality of integrated data records.

6. The method of claim 1, wherein generating the inference associated with the plurality of key performance index values comprises:
generating a plurality of trade scenarios, wherein each trade scenario of the plurality of trade scenarios is associated with a country and an industry;
recognizing a pattern in the plurality of key performance index values associated with each trade scenario of the plurality of trade scenarios; and
generating the inference for each trade scenario of the plurality of trade scenarios based on the recognized pattern.

7. The method of claim 1, further comprising:
receiving a user input through the user interface;
checking the first data source, the second data source, and the third data source for updates associated with the user input;
updating the plurality of key performance index values based on the updates;
updating the inference based on the updated plurality of key performance index values; and
generating an updated recommendation based on the updated inference.

8. A computer system for automatically generating trade recommendations, the system comprising:
a processor;
a memory comprising computer program code, the memory and the computer program code configured to, with the processor, cause the processor to:
obtain a plurality of transaction data records from a first data source, each transaction data record of the plurality of transaction data records comprising a plurality of first data fields;
obtain a plurality of trade data records from a second data source, each trade data record of the plurality of transaction data records comprising a plurality of second data fields;
map the plurality of first data fields to the plurality of second data fields;
generate a plurality of integrated data records by collating the plurality of transaction data records and the plurality of trade data records based on the mapping;
obtain a plurality of regulatory data records from a third data source;
merge the plurality of regulatory data records into the plurality of integrated data records;
derive a plurality of key performance index values for each merged integrated data record of the plurality of merged integrated data records;
generate an inference associated with the plurality of key performance index values;
generate a recommendation associated with the inference; and
display the recommendation on a user interface including automatically arranging the recommendation on the user interface based on the inference.

9. The system of claim 8, wherein each integrated data record of the plurality of integrated data records has a plurality of integrated data fields.

10. The system of claim 9, wherein the plurality of integrated data fields comprises a country, an industry, and a product.

11. The system of claim 8, wherein the memory and the computer program code are configured to, with the processor, further cause the processor to:
assign a set of weights to the plurality of key performance index values;
derive a plurality of weighted key performance index values by applying the set of weight to the plurality of key performance index values; and
combine the plurality of weighted key performance index values to generate a total key performance index value for each merged integrated data record of the plurality of merged integrated data records.

12. The system of claim 8, wherein merging the plurality of regulatory data records into the plurality of integrated data records comprises analyzing the plurality of regulatory data records and matching the plurality of regulatory data records to the plurality of integrated data records.

13. The system of claim 8, wherein generating the inference associated with the plurality of key performance index values comprises:
generating a plurality of trade scenarios, wherein each trade scenario of the plurality of trade scenarios is associated with a country and an industry;
recognizing a pattern in the plurality of key performance index values associated with each trade scenario of the plurality of trade scenarios; and
generating the inference for each trade scenario of the plurality of trade scenarios based on the recognized pattern.

14. The system of claim 8, wherein the memory and the computer program code are configured to, with the processor, further cause the processor to:
receive a user input through the user interface;
check the first data source, the second data source, and the third data source for updates associated with the user input;
update the plurality of key performance index values based on the updates;
update the inference based on the updated plurality of key performance index values; and
generate an updated recommendation based on the updated inference.

15. A computer storage device having computer-executable instructions that, upon execution by a processor, cause the processor to:
obtain a plurality of transaction data records from a first data source, each transaction data record of the plurality of transaction data records comprising a plurality of first data fields;
obtain a plurality of trade data records from a second data source, each trade data record of the plurality of transaction data records comprising a plurality of second data fields;
obtain a plurality of regulatory data records from a third data source;
map the plurality of first data fields to the plurality of second data fields;
generate a plurality of integrated data records by collating the plurality of transaction data records and the plurality of trade data records based on the mapping;
merge the plurality of regulatory data records into the plurality of integrated data records;
derive a plurality of key performance index values for each merged integrated data record of the plurality of merged integrated data records;
generate an inference associated with the plurality of key performance index values;
generate a recommendation associated with the inference; and
display the recommendation on a user interface including automatically arranging the recommendation on the user interface based on the inference.

16. The computer storage device of claim 15, wherein each integrated data record of the plurality of integrated data records has a plurality of integrated data fields, wherein the plurality of integrated data fields comprises a country, an industry, and a product.

17. The computer storage device of claim 15, wherein the computer-executable instructions, upon execution by the processor, cause the processor to:
assign a set of weights to the plurality of key performance index values;
derive a plurality of weighted key performance index values by applying the set of weight to the plurality of key performance index values; and
combine the plurality of weighted key performance index values to generate a total key performance index value for each merged integrated data record of the plurality of merged integrated data records.

18. The computer storage device of claim 15, wherein merging the plurality of regulatory data records into the plurality of integrated data records comprises analyzing the plurality of regulatory data records and matching the plurality of regulatory data records to the plurality of integrated data records.

19. The computer storage device of claim 15, wherein generating the inference associated with the plurality of key performance index values comprises:
generating a plurality of trade scenarios, wherein each trade scenario of the plurality of trade scenarios is associated with a country and an industry;
recognizing a pattern in the plurality of key performance index values associated with each trade scenario of the plurality of trade scenarios; and
generating the inference for each trade scenario of the plurality of trade scenarios based on the recognized pattern.

20. The computer storage device of claim 15, wherein the computer-executable instructions, upon execution by the processor, cause the processor to:
receive a user input through the user interface;
check the first data source, the second data source, and the third data source for updates associated with the user input;
update the plurality of key performance index values based on the updates;
update the inference based on the updated plurality of key performance index values; and
generate an updated recommendation based on the updated inference.
